(19) United States
(12) Patent Application Publication
(10) Pub. No.: US 2026/0160986 A1
(43) Pub. Date: Jun. 11, 2026

(54) LENSLET-INTEGRATED ILLUMINATOR FOR ELIMINATING VIGNETTING-INDUCED ARTIFACTS AND ENHANCING LIGHT THROUGHPUT IN FOURIER PTYCHOGRAPHY

(71) Applicant: UIF (University Industry Foundation), Yonsei University, Seoul (KR)

(72) Inventors: Chulmin JOO, Seoul (KR); R. W. M. Chathuranga Malith RANATHUNGA, Suwon-si (KR); Tae Gyun MOON, Seoul (KR); Jongmin KIM, Seoul (KR)

(73) Assignee: UIF (University Industry Foundation), Yonsei University, Seoul (KR)

(21) Appl. No.: 19/181,590

(22) Filed: Apr. 17, 2025

(30) Foreign Application Priority Data
Apr. 19, 2024 (KR) 10-2024-0052621
Apr. 10, 2025 (KR) 10-2025-0047042

(51) Int. Cl. G02B 21/12; G01N 21/01; G02B 21/36

(52) U.S. Cl. CPC G02B 21/125; G01N 21/01; G02B 21/362; G02B 21/367; G01N 2021/0106

(57) ABSTRACT

Disclosed are a method for removing vignetting of a light source array, a light irradiation apparatus from which the vignetting is removed, a Fourier ptychography apparatus from which the vignetting is removed, and a method for obtaining a FP high-resolution image with a reduced exposure time. The method for removing the vignetting of the light source array includes placing lenses respectively on front surfaces irradiated with light of at least some of light sources included in the light source array, and each lens is disposed such that each light source generates quasi-collimated illumination.

### CROSS-REFERENCE TO RELATED APPLICATION(S)

This application claims the benefit under 35 USC 119 (a) of Korean Patent Application Nos. KR 10-2024-0052621, filed on Apr. 19, 2024 and KR 10-2025-0047042, filed on Apr. 10, 2025, with the Korean Intellectual Property Office, the disclosures of which are incorporated herein by reference in their entirety.

### BACKGROUND

### Field

The present disclosure relates to a method for removing vignetting of a light source array, a light irradiation apparatus from which the vignetting is removed, a Fourier ptychography apparatus from which the vignetting is removed, and a method for obtaining a FP high-resolution image with a reduced exposure time.

### Description of Related Art

An LED array is a light source mainly used in a Fourier ptychography (FP), but this requires a long exposure time and has a problem of causing artifacts resulting from vignetting. The long exposure time may be required mainly by low light intensity and great divergence angle on a sample plane, which may reduce an obtaining speed, while the vignetting may degrade the quality of an image, like “semi-bright and semi-dark” images. To solve such problems, an illuminator capable of providing high illumination along with a uniform illumination vector across an entire FoV may help improve the quality of the FP imaging.

FIG. 1 illustrates the artifacts resulted from the vignetting of the FP. (left) Illumination of an LED panel, commonly used in the FP: θ1 and θ2 showing non-uniform illumination angles of the sample plane; (right) “Semi-bright and semi-dark” image obtaining resulted from intensity measurement using the LED panel when the illumination is close to an NA objective.

Shortening the exposure time in the Fourier ptychography (FP) imaging has been recognized as an important task, and various studies have been conducted therefore. Use of a digital mirror device and an inductive laser beam has been explored as possible ways to reduce the exposure time, but these methods often require complex settings and sophisticated hardware. Such technologies are able to suggest ways to increase an efficiency of the FP imaging and increase the imaging speed, but at the same time, a need for a simpler and more effective solution continues to be raised, considering that they may cause problems of complexity in implementation and costs.

The artifacts resulted from the vignetting present significant challenges in the Fourier ptychography (FP). In an existing FP scheme, such a “semi-bright and semi-dark” image was often removed, but this may play an important role in recovery of low-frequency phase information of a sample. Although this problem may be solved by placing a condenser between the LED arrays to achieve the uniform illumination vector across the entire field of view (FOV), there is a limitation that this method does not necessarily improve illumination efficiency, resulting in longer exposure time.

Thus, in the present disclosure, a new approach has been proposed to place a lens array on the LED array so that each lenslet aligned with an offset of each LED axis produces quasi-collimated illumination at various angles of incidence. This approach improves light throughput, obtaining a dark field (FOV) image with an exposure time of several milliseconds and providing the uniform illumination vector across the entire DF, leaving no artifacts resulting from the vignetting.

### SUMMARY

The present disclosure is intended to reduce an exposure time and artifacts resulted from vignetting that may occur during a high-resolution image obtaining process. To this end, the present disclosure proposes a method that utilizes a lens array precisely arranged on top of an LED array to adjust and optimize light emitted from each LED, thereby achieving uniform illumination and improved illumination efficiency. This approach has a potential to improve an image quality and significantly reduce the exposure time required for image capture, especially in a low illuminance condition. Furthermore, the method may reduce a need for complex and costly hardware and may provide an imaging system that is more accessible to a user.

One aspect of the present disclosure provides a method for removing vignetting of a light source array including placing lenses respectively on front surfaces irradiated with light of at least some of light sources included in the light source array, wherein each lens is disposed such that each light source generates quasi-collimated illumination.

In an embodiment, the lenses may be equally prepared with predetermined material and shape, and each light source may be disposed to generate the quasi-collimated illumination by adjusting a distance of each lens to each light source and an offset distance between a center of each lens and a center of each light source.

In an embodiment, each light source may be prepared to include an LED.

Another aspect of the present disclosure provides a light irradiation apparatus with vignetting removed including a light source array, and a lens array including lenses respectively disposed on front surfaces irradiated with light of at least some of light sources included in the light source array, wherein each lens is disposed such that each light source generates quasi-collimated illumination.

In an embodiment, the lenses may have the same material and shape, and each light source may be disposed to generate the quasi-collimated illumination by adjusting a distance of each lens to each light source and an offset distance between a center of each lens and a center of each light source.

In an embodiment, each light source may include an LED.

Still another aspect of the present disclosure provides a Fourier ptychography apparatus with vignetting removed including a light irradiation apparatus including a sample portion where a sample to be irradiated with light is able to be disposed, a light source assembly that irradiates light to the sample portion, a sensor that obtains an image generated from the sample portion by light irradiated by the light source assembly, and a calculator that calculates and obtains a high-resolution image from the image, wherein the light source assembly includes: a light source array, and a lens array including lenses respectively disposed on front surfaces irradiated with light of at least some of light sources included in the light source array, wherein each lens is disposed such that each light source generates quasi-collimated illumination on the sample portion.

In an embodiment, the lenses may have the same material and shape, and each light source may be disposed to generate the quasi-collimated illumination by adjusting a distance of each lens to each light source and an offset distance between a center of each lens and a center of each light source.

In an embodiment, the light source may emit light to the sample portion in two or more patterns, the sensor may obtain two or more images from light irradiated in the two or more patterns, and the calculator may calculate the high-resolution image from the two or more images.

In one embodiment, each light source may include an LED.

In one embodiment, the light source assembly may include a bright field light source and a dark field light source.

In one embodiment, the bright field light source may be configured to form an asymmetric pattern.

In one embodiment, the dark field light source may be configured to form six or more centro-symmetric patterns.

Yet another aspect of the present disclosure provides a method for obtaining a Fourier FP high-resolution image with a reduced exposure time including obtaining a high-resolution image of a sample to be analyzed using the Fourier ptychography apparatus with the vignetting removed according to one of claims 7 to 11, wherein an exposure time for the sensor to obtain the image is reduced to 1/70 to 1/125 of an exposure time required when the lens array is removed from the light irradiation apparatus.

Specifically, this new and efficient LED-based illuminator for the Fourier ptychography (FP) imaging, designed to provide the high illumination and the uniform illumination vector throughout the FoV, may be of great help in reducing the time in the image obtaining process and eliminating the artifacts caused by the vignetting. The introduction of such an illuminator presents the possibility of significantly improving the imaging quality, especially in the application that requires the rapid and accurate imaging of the wide range of region. In addition, the use of the LED provides additional advantages such as increasing energy efficiency and reducing maintenance costs in long-term use. This illumination system may contribute to generation of a high-resolution and high-contrast image, which is essential for clearly capturing a fine structure of a complex sample.

Effects of the present disclosure are to improve the overall uniformity of the illumination, reduce the exposure time, and eliminate the artifacts resulting from the vignetting. In particular, this new approach using the lens array provides the possibility to obtain the more precise and clear image of the object to be photographed by optimizing the distribution of light generated from the light sources. This may be particularly useful in the research and the application where the high-resolution imaging requirements are highlighted. In addition, this technology may be easily used by non-professionals, thereby providing imaging solutions to a wide user base.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 illustrates artifacts resulting from vignetting of FP.

FIG. 2A illustrates a comparative analysis between a lenslet-integrated illuminator and a conventional LED panel with respect to light propagation and imaging quality in Fourier ptychography.

FIG. 2B is a photograph of an LED panel used in Example of the present disclosure.

FIG. 3A illustrates a Zemax simulation of a light distribution on a detector plane, in accordance with an embodiment of the present disclosure.

FIG. 3B presents simulated illuminance intensity distributions at the detector plane under different LED illumination configurations.

FIG. 4 illustrates the experimental setup for conducting lens array-based Fourier ptychography (coded structured-Fourier ptychography, CS-FP), in accordance with an embodiment of the present disclosure.

FIG. 5A illustrates quantitative phase reconstruction results of a USAF resolution target, comparing the imaging performance between a lenslet-integrated LED (L-LED) illuminator and a conventional LED panel.

FIG. 5B presents quantitative comparisons of recovered phase profiles across selected spatial coordinates in different regions of interest (ROIs) from the field of view, as obtained through Fourier ptychographic reconstruction.

FIG. 6 illustrates multiplexed illumination schemes for bright-field (BF) and dark-field (DF) imaging. BF images are acquired using objective numerical aperture (NA)-matched asymmetric illuminations, wherein the corresponding frequencies cover up to two times the objective NA. For DF imaging, centro-symmetric multiplexed illumination within the same illumination ring is employed, covering the DF Fourier space up to four times the objective NA.

FIG. 7 shows the phase reconstruction results along with the corresponding synthetic phase transfer functions (PTFs) for each illumination condition. The first three columns depict NA-matched BF illuminations with varying numbers of BF images, where N_{BF}=1, 2, and 3, respectively. The rightmost shows BF illuminations using an illumination NA smaller than the objective NA, with a total of three BF images (N_{BF}=3).

FIG. 8A presents numerical simulations conducted to evaluate image reconstruction performance under various dark field (DF) illumination conditions. In all simulations, three bright field (BF) illuminations were applied using numerical-aperture-matched asymmetric patterns.

FIG. 8B shows an example of a random DF illumination configuration with N_{DF}=6.

FIG. 8C presents a quantitative comparison of image reconstruction performance for both illumination strategies.

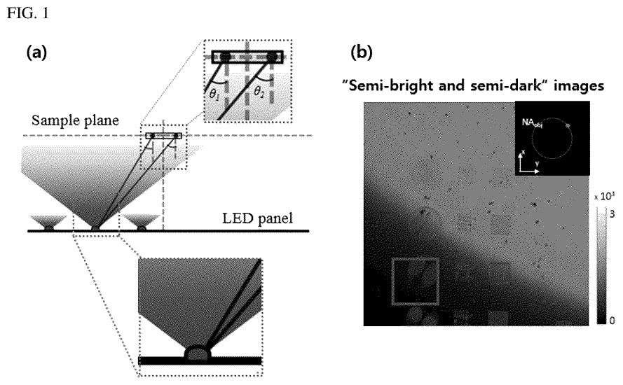

### DETAILED DESCRIPTIONS

Hereinafter, an embodiment of the present disclosure will be described in detail with reference to the accompanying drawings. Because the present disclosure may make various changes and may have various forms, specific embodiments are to be illustrated in the drawings and to be described in detail in the present document. However, this is not intended to limit the present disclosure to a specific disclosed form, and it should be understood that all changes, equivalents, and substitutes included in the spirit and technical scope of the present disclosure are included. Similar reference numerals are used for similar components while describing each drawing. In the accompanying drawings, dimensions of structures are exaggerated for clarity of the present disclosure.

Terms used in the present application are used only to describe the specific embodiments and are not intended to limit the present disclosure. A singular expression includes a plural expression, unless the context clearly dictates otherwise. In the present application, terms such as “include” or “have” are intended to designate those features, numbers, steps, operations, components, or combinations thereof described herein exist, and should be understood as not precluding a possibility of presence or addition of one or more other features, numbers, steps, operations, components, or combinations thereof. In context of the present document, terms such as “about” may mean about ±1%, about ±2%, about ±3%, about ±4%, about ±5%, about ±6%, about ±7%, about ±8%, about ±9%, or about ±10% of values described herein.

In addition, description of one aspect of the present disclosure may be applied in the same or similar manner to the same or similar component or terminology in description of another aspect.

Unless otherwise defined, all terms used herein, including technical or scientific terms, have the same meanings as those generally understood by those of ordinary skill in the art to which the present disclosure belongs. Terms such as those defined in commonly used dictionaries should be interpreted as having a meaning consistent with a meaning in context of the related art, and are not interpreted in an ideal or excessively formal meaning unless explicitly defined in the present application.

A method for removing vignetting of a light source array according to an embodiment of the present disclosure may include respectively placing lenses on front surfaces to which light is irradiated of at least some of light sources included in a light source array. Accordingly, a more uniform light distribution may be achieved in an entire irradiation region. Such uniform illumination has a potential to improve homogeneity of an image and significantly reduce the vignetting effect that is particularly likely to occur at an edge of imaging. In addition, this method may also contribute to reducing an exposure time by improving efficiency of illumination on a sample, which is advantageous in meeting a high-speed imaging requirement. In addition, under the improved illumination condition, contrast and sharpness of the image required to capture more detailed details may be improved.

In context of the present document, an array may mean a series of elements arranged based on a certain rule. In particular, the light source array indicates that several light sources are arranged based on a specific pattern or order. Such an arrangement has a possibility of optimizing the distribution of light emitted from the light sources and providing the uniform illumination to a region to which light is irradiated. By placing the lens on each element of the light source array, light of each light source may be adjusted and concentrated or distributed in a specific direction, which may improve overall performance of an optical system. Moreover, this method may be helpful for applications in various fields by eliminating the vignetting phenomenon in a specific region and enabling more detailed and precise imaging.

In context of the present document, the vignetting refers to a phenomenon in which an edge of the image becomes darker than a center. This occurs mainly by limitations of optical properties of the lens or the illumination arrangement. The method for individually placing the lenses on the light source array presented in the present disclosure provides a possibility of eliminating such a vignetting phenomenon. By more uniformly distributing or concentrating light via the lenses respectively corresponding to the respective light sources, the illumination of the entire image may be improved, and in particular, detailed information of the edge of the image may be made clearer. This may be particularly useful for applications that require high-quality images in a variety of fields such as science, medicine, photography, and the like. Thus, this approach may help not only to improve overall image quality, but also to solve a quality degradation problem caused by the vignetting.

In an embodiment, each lens may be disposed such that each light source generates quasi-collimated illumination. When each lens is disposed to harmonize with each light source to generate the quasi-collimated illumination, this may allow light emitted from the light source to be more concentrated or uniformly distributed with a specific directionality. Adjusting light in this manner may help to shorten the exposure time and improve the uniformity of the image, and may contribute to achieving fine image quality required especially in an optical system. In addition, such a quasi-collimated illumination method has an effect of greatly removing the vignetting phenomenon, thereby improving the sharpness and brightness up to the edge of the image. This may play an important role in optimizing an image obtaining process in scientific research, medical diagnosis, and various applications where high-resolution is highly needed.

In context of the present document, the quasi-collimated or the quasi-collimated illumination means a state in which light emitted from the light source is adjusted to be almost parallel. Such an illumination scheme may help to minimize the dispersion of light especially in the optical system and improve the uniformity of the illumination. In the present disclosure, by generating such quasi-collimated illumination via the lens corresponding to each light source, provided is a possibility of reducing optical problems such as the vignetting while improving the resolution and the sharpness of the image. This may mean an important development in the field of optical imaging, and may be usefully used in applications such as medical imaging, life science, industrial inspection, and the like, which require high-precision imaging.

The lenses may be prepared with different materials or shapes, or may be prepared with the same material and shape. In an embodiment, the lenses may be prepared in the same manner with predetermined material and shape. Options by which the lenses may be prepared with the different materials or shapes or with the same material and shape may provide flexibility in optimizing optical performance for various applications and environments of the light source array. An embodiment of preparing the lenses with the same material and shape may help to achieve uniform optical properties and performance, which may increase predictability and reliability of an entire system. On the other hand, selective use of the lenses of the different materials or shapes enables more precise response to a specific illumination condition or a special imaging requirement, which may contribute to expanding versatility and coverage of the system.

In an embodiment, an operator may construct the array using a customized lens. By optimizing variables such as a lens material, a lens curvature radius, and a lens conic constant, the quasi-collimated illumination may be obtained at a desired angle of incidence. In an embodiment, a method for constructing the array using the customized lens provides a possibility of customizing a performance of the optical system based on a specific imaging requirement. Via the optimization of the variables such as the lens material, the curvature radius, and the conic constant, a user may develop an optical design suitable for various conditions and application programs. This may be particularly useful in an advanced application with a unique illumination requirement, and may help to achieve better image quality and optical precision. In addition, the construction of the optical system via the customized lens may increase flexibility in the imaging process, and allow the optical system to be easily adjusted based on an experimental condition or a characteristic of an object.

In an embodiment, by adjusting a distance of each lens to each light source and a offset distance between a center of each lens and a center of each of light source, each light source may be disposed to generate the quasi-collimated illumination. Such adjustability allows fine control of directionality and concentration of light emitted from each light source, thereby providing an opportunity to increase efficiency and uniformity of the entire illumination system. In particular, by adjusting the placement of the lens, the distance to the light source, and the offset distance, the optical system may be optimized to meet the specific illumination requirement. This helps the optical system to produce a high-quality image while having a wider field of view (FOV) in the various applications.

The distance of each lens to each light source may be adjusted to be close to a back focal distance (BFL), but may not exactly match. According to a definition of the BFL, when the light source and the lens are spaced apart from each other by the BFL in a situation where axes thereof exactly match each other, light forms the quasi-collimated illumination in a direction parallel to the axes. However, when an objective direction of the quasi-collimated illumination is not exactly parallel to the axes, it may be necessary to introduce a certain offset between the axes of the light source and the lens for adjustment. This provides theoretical flexibility. In this situation, the light source may have to be located on a focal curved surface formed at the rear of the lens, rather than on a BFL plane of the lens, which means that the axial distance between the light source and the lens may actually be somewhat smaller than the BFL.

In context of the present document, the offset distance refers to a separation distance between the lens center and the light source center. By adjusting such a distance, light may be adjusted, concentrated, or uniformly distributed in a specific direction by adjusting a path of light generated from the light source. The fact that such adjustment is available means that characteristics of the illumination may be finely customized to suit different application programs and imaging needs. For example, by optimizing the offset distance, the vignetting effect may be reduced, and the uniformity of the light sources may be improved, thereby improving the quality of the entire image. In addition, such adjustment may be used for a purpose of providing stronger illumination to a specific region or maximizing the efficiency of the light source.

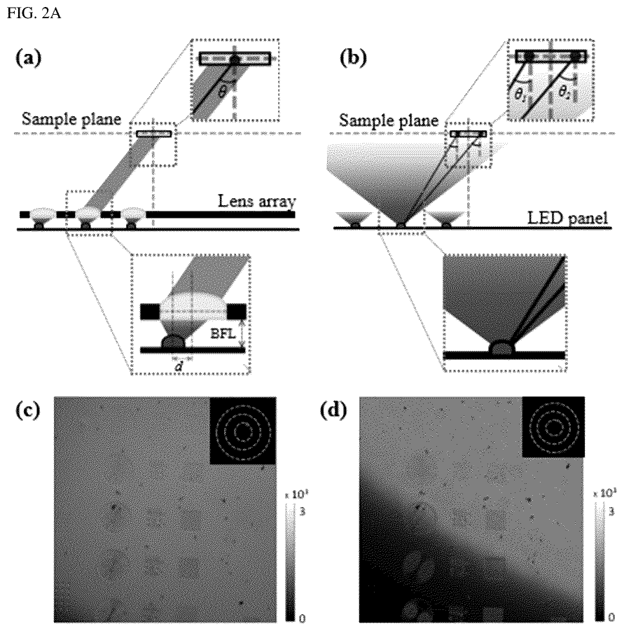

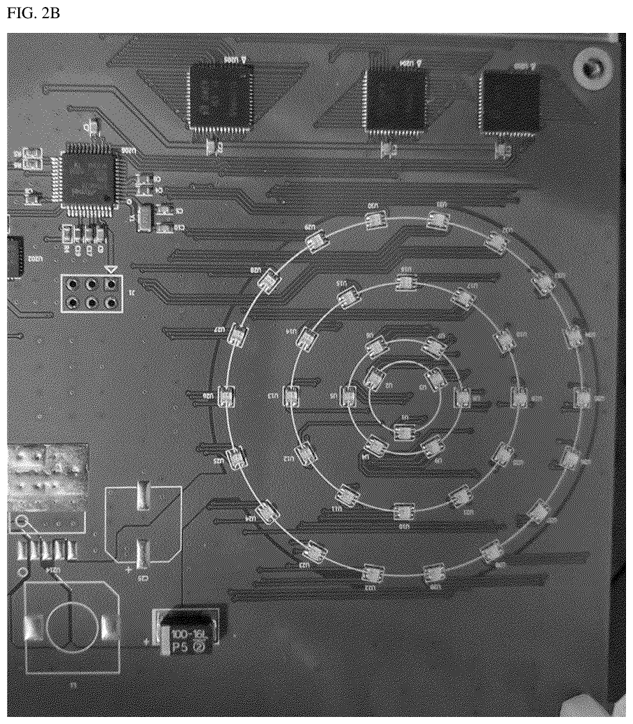

(a) in FIG. 2A illustrates an example of generating the quasi-collimated illumination via the placement of the lens. The distance of each lens to each light source and the offset distance may be adjusted to generate the quasi-collimated illumination. This may be implemented by setting the distance of each lens to each light source and the offset distance using a technology known at the time of the present application. For example, Zemax OpticStudio may be used to derive the distance to each light source and the offset distance required when placing the lens. Setting such parameters using the known technology such as the Zemax OpticStudio provides a way to make design and optimization processes of the optical system more effective and efficient. Accordingly, the user has a potential to quickly determine an optimal placement of the lens without complex calculations and trial and error, and ultimately obtain a better imaging result.

FIG. 2A illustrates a comparative analysis between a lenslet-integrated illuminator and a conventional LED panel with respect to light propagation and imaging quality in Fourier ptychography.

In the upper left subfigure, a schematic diagram of the lenslet-integrated illuminator is shown. The LED array is combined with a lens array, where each lenslet is aligned with an offset d from the center of its corresponding LED. This configuration enables quasi-collimated illumination at various angles of incidence θ to the sample plane.

In the upper right subfigure, a schematic of a conventional LED panel is shown. In this configuration, light from individual LEDs diverges freely without any optical correction, resulting in non-uniform illumination angles θ1 and 02 across the sample plane.

The lower left subfigure presents an experimental bright field image obtained using the lenslet-integrated illuminator. The image reveals uniform illumination across the sample plane, and the inset displays the illumination coverage in Fourier space, which corresponds to the numerical aperture (NA) of the objective. The grayscale bar at the right indicates the intensity distribution, confirming consistent signal levels across the field of view.

In contrast, the lower right subfigure shows a bright field image acquired using the conventional LED panel. Here, significant vignetting artifacts are evident, particularly in the lower region of the image where intensity falls off drastically. The inset shows a limited and uneven Fourier space coverage, indicating that light from off-axis LEDs fails to reach the sample uniformly. This results in degraded phase reconstruction and reduced imaging performance.

Overall, FIG. 2A demonstrates that the lenslet-integrated illumination approach significantly mitigates vignetting effects, enhances angular illumination uniformity, and enables high-quality image acquisition in Fourier ptychography systems.

In context of the present document, a dictionary meaning of the field of view (FOV) is a range of a space that a camera or another imaging device may view at a time. Adjusting the FOV is an important factor in the imaging system, and an optimal FOV setting may vary depending on a specific application program. For example, a wide FOV may be useful for overall observation of a large sample, and a narrow FOV may be more suitable when detailed imaging is required. Such adjustment may help the user to obtain an image that is best suited for a particular experimental or observation purpose, and may help establish flexible imaging strategies for samples of various sizes and types. In addition, the optimization of the FOV may prevent a loss of important information in the imaging process and enable efficient data analysis, thereby improving quality and accuracy of the overall experiment.

One of advantages of the FP is the wide FOV. However, because the artifacts resulted from the vignetting occur frequently at an edge of the FOV (because the vignetting is particularly severe), this advantage may be weakened. The present disclosure is characterized in effectively solving this problem. The approach of the present disclosure that reduces the artifacts resulted from the vignetting while maximizing the wide FOV of the FP offers a potential to improve the overall performance of the optical system. In particular, this method ensures uniform illumination even at the edge, thereby improving the quality of the entire image and enabling more accurate and detailed imaging. Such improvement may have a significant implication in a variety of applications, such as the scientific research, the medical diagnosis, and the precise industrial inspection. By solving the vignetting problem, the user may take full advantage of the advantages of the FP technology, which may help to increase the uniformity and the accuracy of the image while allowing a wider range of FOV to be effectively captured in the high-resolution image obtaining process.

A type of the light source is not particularly limited. In an embodiment, each light source may be prepared to include an LED. The LED is advantageous because of its energy efficiency, long lifespan, and various color temperature adjustability. These characteristics may satisfy the specific illumination requirements required in a variety of fields, such as the scientific experiment, the medical imaging, and the industrial inspection. In addition, by using the LED, adjustment and control of the light source arrangement may be facilitated, which may contribute to the overall performance improvement of the optical system.

In one example, a light irradiation apparatus from which the vignetting is removed according to an embodiment of the present disclosure may include: a light source array; and a lens array including lenses respectively disposed on front surfaces to which light is irradiated of at least some of light sources included in the light source array. Accordingly, a possibility to more precisely control the distribution and the direction of light is provided. This is particularly useful for the high-resolution imaging and the precision measurement operation where the uniform illumination is essential in the optical system. By adjusting the concentration and the diffusion of light generated using the lens array, the uniformity of the illumination may be increased and the vignetting phenomenon may be reduced. Such a method may satisfy the requirements in the various application fields such as the scientific research, the medical diagnosis, the industrial inspection, and the like by allowing the user to obtain a clearer and more accurate image.

In an embodiment, each lens may be disposed such that each light source generates the quasi-collimated illumination. In an embodiment, the lenses may have the same material and shape, and may be arranged such that the distance of each lens to each light source and the offset distance between the center of each lens and the center of each light source are adjusted for each light source to generate the quasi-collimated illumination. In an embodiment, each light source may include the LED.

In one example, a Fourier ptychography apparatus from which the vignetting is removed according to an embodiment of the present disclosure may include a light irradiation apparatus including: a sample portion in which a sample, which is to be irradiated with light, may be disposed; a light source assembly that irradiates light to the sample portion; a sensor that obtains an image generated from the sample portion by light irradiated by the light source assembly; and a calculator that calculates and obtains a high-resolution image from the image, wherein the light source assembly includes: a light source array; and a lens array that includes lenses respectively disposed on front surfaces to which light is irradiated of at least some of light sources included in the light source array, wherein each lens is disposed such that each light source generates quasi-collimated illumination on the sample portion.

In context of the present document, the ptychography or the ptychography apparatus refers to an advanced imaging technology that reconstructs multiple images obtained from various angles via a mathematical algorithm to generate a high-resolution image of the sample. This technology may be particularly useful for imaging of a transparent or low contrast sample, and may help to closely observe a microstructures such as a biological tissue or a nanomaterial. The uniform illumination provided via the light irradiation apparatus from which the vignetting is removed according to the present disclosure may contribute to improving the image quality and shortening a data obtaining time in the ptychography process. This may allow researchers to obtain the high-resolution image more efficiently and expand applicability in fields such as scientific discovery and the medical diagnosis. Thus, such an approach may help broaden a scope of the imaging using the ptychography and increase utilization of the corresponding technology.

In an embodiment, the lenses may have the same material and shape, and may be arranged such that the distance of each lens to each light source and the offset distance between the center of each lens and the center of each light source are adjusted for each light source to generate the quasi-collimated illumination. In an embodiment, the light source assembly may irradiate light to the sample portion in two or more patterns, the sensor may obtain two or more images from light irradiated in the two or more patterns, and the calculator may calculate the high-resolution image from the two or more images. In an embodiment, each light source may include the LED.

In one embodiment, the light source assembly may include a bright field light source and a dark field light source. In the context of the present disclosure, the term “bright field light source” refers to an illumination configuration in which the illumination angles are matched to the numerical aperture (NA) of the objective lens, allowing for the acquisition of images based on directly transmitted light through the sample. As described below, such illumination is often implemented in an asymmetric manner, which can be advantageous for the reconstruction of low-frequency phase information.

In the context of the present disclosure, the term “dark field light source” refers to a configuration that enables the detection of only scattered light from the sample, by using illumination incident from outside the NA of the objective lens. This configuration may be useful for emphasizing high-frequency components of phase information. A combination of these two illumination schemes can leverage the strengths of each to cover a broader frequency spectrum and enhance the overall quality of phase reconstruction.

In one embodiment, the bright field light source may be configured to form an asymmetric pattern. This enables low-frequency phase components of the sample to be collected with minimal loss and allows for precise phase reconstruction, taking into account the projection characteristics of the optical transfer function. Furthermore, since uniform illumination is provided from various incident angles, it can aid in observing the overall structure of the sample with minimal distortion.

In one embodiment, the dark field light source may be configured to form six or more centro-symmetric patterns. This allows high-frequency information to be collected more stably, and improves both the convergence speed and accuracy of the reconstruction algorithm. In addition, randomly activated centro-symmetric LED pairs within the same illumination ring can contribute to uniformly sampling the Fourier space of the sample, which may help reduce errors during the demultiplexing process and enhance image throughput.

In one example, a method for obtaining a Fourier FP high-resolution image in which the exposure time is reduced according to an embodiment of the present disclosure may include obtaining a high-resolution image of a sample to be analyzed using a Fourier ptychography apparatus. In an embodiment, the Fourier ptychography apparatus may be the Fourier ptychography apparatus from which the vignetting is removed according to an embodiment of the present disclosure described above. With this method, there is a possibility of obtaining the high-quality image even with the shorter exposure time, which may be particularly useful in an application requiring fast image processing. The light irradiation method from which the vignetting is removed may improve the overall efficiency of the optical system, allow details of the image to be captured more clearly, and at the same time, save time in the data collection process.

In an embodiment, the exposure time for the sensor to obtain the image may be reduced to be about 1/70 to 1/125 of an exposure time required when the lens array is removed from the light irradiation apparatus. Such reduction in the exposure time means that the light irradiation apparatus has excellent ability to efficiently concentrate and disperse light. Such characteristics may provide great advantages, especially in an application requiring continuous image capturing or high-speed imaging. For example, in an experiment in which a fast-moving sample should be observed or a change over time should be precisely recorded, the short exposure time enables fast data collection while maintaining image clarity. Furthermore, such improvement may also have an effect of reducing energy consumption in the imaging process, which is particularly advantageous when long-time observation or large data collection is required. This effect will become apparent in embodiments to be described below.

Hereinafter, embodiments of the present disclosure will be described. However, the embodiments to be described below are only some embodiments of the present disclosure, and a range of the present disclosure is not limited to the following embodiments.

The inventor placed the lens array on top of an LED array. Here, each lenslet was carefully aligned with the offset of the LED axis, resulting in the quasi-collimated illumination at the various angles of incidence. Such an illuminator design greatly improves light throughput, allowing an DF image to be obtained with an exposure time of several milliseconds and providing the uniform illumination vector across the entire FOV.

### Method

In the present disclosure, collimation of light may be implemented by optimizing the lens material, the curvature radius, the conic constant, and the like. In an embodiment of the present disclosure, it is based on results of experimental confirmation using commercially available lenses. Accordingly, in the present disclosure, optimization was achieved by adjusting a distance between the lens and a light source. This approach was chosen by the inventor as one of several methods for optimizing the collimation. This approach, adopted in the present disclosure, has an advantage of being able to provide precision needed to generate quasi-collimated illumination, despite the simplicity of adjusting the distance between the light source and the lens. This method increases flexibility of an optical system design, especially by utilizing the commercially available lenses, and suggests a possibility of obtaining effective results without additional customized production. By only adjusting the distance between the light source and the lens, a vignetting phenomenon in the optical system may be minimized and uniform illumination distribution may be achieved, thereby contributing to improvement of quality required for high-resolution imaging.

However, the collimation of light in the present disclosure is not particularly limited to the above-described method. For example, the operator may directly optimize the lens material, the curvature radius, the conic constant, and the like. Such an additional optimization process further improves a performance of the optical system and provides an opportunity to more precisely fit a requirement of a specific application. Via the direct lens design and the optimization, the inventor may fine-tune optical properties of the optical system and achieve excellent imaging results, especially under a difficult illumination condition.

FIG. 2A illustrates illumination comparison between an L-LED illuminator and an LED panel. (a) Schematic diagram of the L-LED illuminator. d and BFL represent offsets from an LED axis to a lens and to a back focal plane of a small lens, respectively. (b) Illumination circuit diagram of the LED panel. (c) Intensity measurement using the L-LED illuminator-illumination consistent with objective NA. (d) Intensity measurement using the LED panel.

An LED illuminator, called the lenslet-LED illuminator (L-LED), is composed of two main components, the LED panel and the lens array. As a lens arrangement, small commercial lenses (APL0609, Thorlabs, #36-627, and Edmund optics) mounted on a 3D printing casing were used. Each lenslet was carefully aligned with the offset of the corresponding LED to obtain illuminations tilted and overlapped on a sample plane at various angles of incidence ((a) in FIG. 2A).

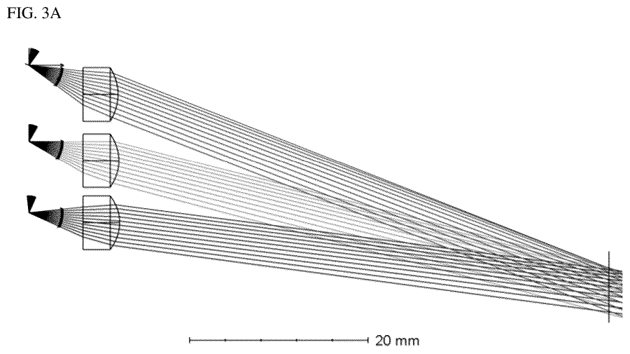

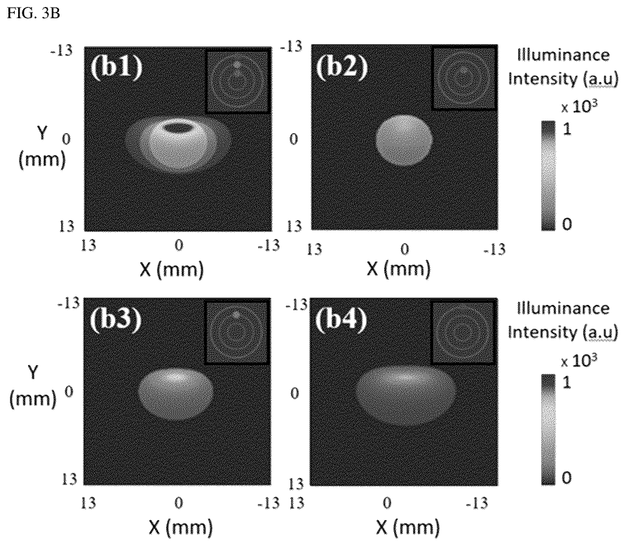

To obtain the uniform illumination vector by determining appropriate values of the LED offset and the back focal distance, an optimization feature built into the Zemax OpticStudio software was utilized. An LED light source was modeled as a point light source. Simulations were performed on three representative LEDs corresponding to respective rings. FIG. 3A and FIG. 3B illustrate simulation results, with each illumination beam overlapping the sample plane to represent the uniform illumination vector across the entire FoV. A diameter of the lenslet was selected in consideration of a pitch size of the LED and the FoV of the optical setting, so that the diameter of the lenslet is smaller than the LED pitch and greater than the FoV. Based on dimensions obtained in the simulations, the 3D printing case is fabricated using photoplastic 3D printing.

The number of images required for the Fourier ptychography (FP) varies depending on a desired resolution improvement and a specific application program. In the present experimental example, an LED panel with 39 LEDs was used, which is illustrated in FIG. 2B. A process operation scheme is as follows: Light is irradiated to a sample at various illumination angles, one at a time. Each LED of the panel may be turned on individually. When the LED is activated, a lens located on the LED produces quasi-collimated illumination at a corresponding angle on the sample plane. Light that interacts with the sample is collected by a camera. The process is repeated for each LED of the panel, and each LED generates quasi-collimated illumination at a different angle. Further, an image is obtained from each illumination. Settings of the present experimental example are summarized as follows: 39 LEDs, 39 lenses, 39 different illumination angles, and 39 captured images synthesized into high-resolution images.

### Experimental Results

The inventor experimentally validated the method according to an embodiment of the present disclosure using an LED-based microscope (4×/0.13 NA objective lens). A customized LED panel (QT-Brightek, SMD 0606 RGB LED) was used as the light source and placed 63 mm above the sample to obtain a synthetic NA 0.49. Images were obtained using an image sensor (The Imaging Source, DFK 38U541, pixel size 2.74 μm).

FIG. 3A illustrates a Zemax simulation of a light distribution on a detector plane, in accordance with an embodiment of the present disclosure. The figure demonstrates the formation of tilted and overlapping illumination beams at various angles of incidence, enabled by a lenslet-integrated illumination system. Three representative LEDs are shown, each paired with a corresponding lenslet. The LED-lens pairs are configured such that the emitted rays are redirected to form quasi-collimated beams. Each beam is projected toward the same target plane—representing the sample plane or the detector plane—at a distinct angle. The simulation confirms that the illumination beams, though originating from spatially separated sources, converge uniformly across the target region. This overlapping of illumination angles is essential for achieving a uniform illumination vector across the field of view (FoV), a key requirement in Fourier ptychography.

FIG. 3B presents simulated illuminance intensity distributions at the detector plane under different LED illumination configurations. Each subfigure shows the result of a Zemax simulation, where one or more LEDs within the LED-lenslet array are selectively turned on. The colorbar indicates relative illuminance intensity in arbitrary units (a.u.), and the X and Y axes represent spatial coordinates on the detector plane in millimeters. In the upper left subfigure, all three LEDs—red (outer ring), green (middle ring), and blue (inner ring)—are simultaneously turned on. In the upper right subfigure, only the blue LED in the inner ring is activated. In the lower left subfigure, only the green LED in the middle ring is turned on. In the lower right subfigure, only the red LED in the outer ring is activated. These results confirm that the proposed lenslet-integrated illumination system allows precise angular control and spatial mapping of each LED's contribution to the detector plane.

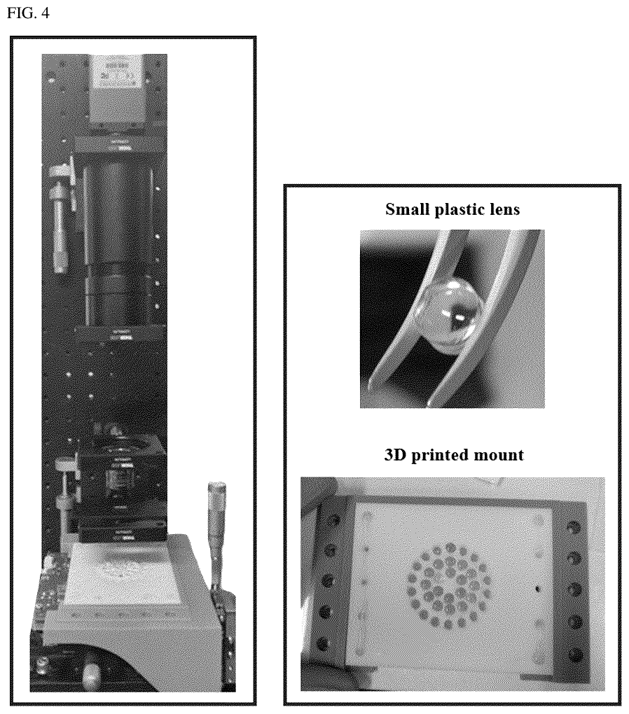

FIG. 4 illustrates the experimental setup for conducting lens array-based Fourier ptychography (coded structured-Fourier ptychography, CS-FP), in accordance with an embodiment of the present disclosure. On the left side of the figure, a complete optical system is shown. On the right side, two key components of the custom illuminator are presented. The upper image shows a close-up of a small plastic lens, which is used as the lenslet in the array. This lens is commercially available and is selected for its compact form factor and suitable focal properties for generating quasi-collimated illumination. The lower image displays the 3D-printed mount that holds the LED-lenslet array. The mount contains circular holes precisely aligned to accommodate individual lenses, arranged in a concentric pattern corresponding to the positions of the LEDs beneath. This configuration allows selective activation of individual LEDs to produce directional quasi-collimated beams at varying angles of incidence.

### Long Exposure Time Issue

TABLE 1

| | Exposure time: | Exposure time: |
|---|---|---|
| | LED panel | L-LED illuminator |
| Dark field images | 250 ms | 2 ms |
| Bright field images | 35 ms | 0.5 ms |

The exposure times for the measurements were compared between the LED panel and the L-LED illuminator. The exposure time of the LED panel was 250 ms, but the use of the L-LED illuminator allowed the exposure time to be reduced to 2 ms for the same SNR. This corresponds to a 1/125× improvement in the DF image obtaining. For a bright field image, the exposure time was reduced from 35 ms to 0.5 ms, corresponding to a 1/70× improvement.

### Vignetting-Induced Artifacts

To highlight a function of the lenslet-LED illuminator, an experiment was performed using both the illuminator and the existing LED panel. The sample was placed at an edge of the FoV to show a function of a method for reconstructing phase information across the entire FoV. Phase reconstruction of the FoV edge (an ROI 1) showed a resolution of 0.78 μm, similar to that of a center. However, unlike the center ROI, artifacts appeared, possibly because of an expanded aberration of the FoV edge. Phase reconstruction using the existing LED panel showed significant artifacts, which severely degraded the imaging resolution obtained, highlighting the effect of illuminator.

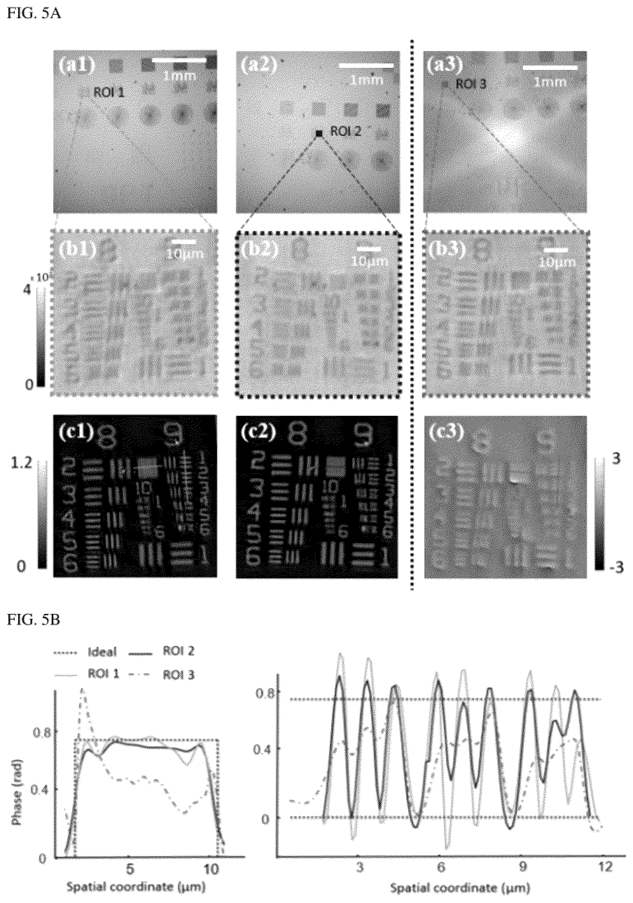

FIG. 5A illustrates quantitative phase reconstruction results of a USAF resolution target, comparing the imaging performance between a lenslet-integrated LED (L-LED) illuminator and a conventional LED panel. The figure highlights bright field (BF) intensity images, magnified views of selected regions of interest (ROIs), and corresponding phase maps, with attention to performance at both the center and edge of the field of view (FoV).

The upper left subfigure shows a BF full-FOV image captured using the L-LED illuminator. The upper center subfigure presents another BF image taken with the L-LED illuminator, this time focused on ROI 2, positioned at the center of the FoV. In contrast, the upper right subfigure shows a BF image acquired using the conventional LED panel, with ROI 3 located again at the edge of the FoV. The middle left, middle center, and middle right subfigures respectively provide magnified views of ROIs 1, 2, and 3.

The lower left and lower center subfigures display quantitative phase maps reconstructed from the L-LED measurements at ROI 1 and ROI 2, respectively. These maps confirm successful recovery of fine structural phase information, consistent across both center and edge positions. The recovered features are sharp, and phase contrast is well maintained throughout. In the lower right subfigure, the phase map reconstructed from the conventional LED panel (ROI 3) shows significant artifacts and distortions. The poor illumination at the FoV edge results in unreliable phase reconstruction, limiting the utility of the system for wide-field quantitative imaging.

Overall, FIG. 5A confirms that the L-LED illuminator enables artifact-free, high-fidelity phase reconstruction across the entire FoV—including edge regions—while the conventional LED panel suffers from severe vignetting and associated degradation in phase retrieval performance.

FIG. 5B presents quantitative comparisons of recovered phase profiles across selected spatial coordinates in different regions of interest (ROIs) from the field of view, as obtained through Fourier ptychographic reconstruction. These line plots directly correspond to the phase maps illustrated in FIG. 5A and serve to assess the spatial accuracy and fidelity of the reconstructed phase under different illumination conditions.

The left plot in FIG. 5B shows the phase profile across a structured object with a square phase step. Both L-LED profiles (ROI 1 and ROI 2) closely follow the ideal square shape, with minimal distortion or baseline drift, demonstrating that high-fidelity phase retrieval is maintained across the field. In contrast, the conventional LED panel (ROI 3) exhibits phase underestimation, smoothing of the step transition, and significant deviation from the true phase structure due to vignetting and reduced signal-to-noise ratio.

The right plot illustrates the phase response across a periodic line pattern, used to assess high-frequency phase resolution. The L-LED-based reconstructions show high contrast and periodicity that closely match the ideal values, indicating excellent modulation transfer and recovery of fine spatial details. On the other hand, the ROI 3 profile demonstrates reduced phase modulation depth and poor periodicity, confirming that the conventional LED panel fails to reconstruct high-frequency phase components accurately, particularly in the outer regions of the field of view.

These results collectively confirm that the lenslet-integrated L-LED illuminator maintains robust phase reconstruction performance across both low- and high-frequency components, and across the entire field of view. The proposed illumination system thus enables reliable, high-resolution, and wide-field quantitative phase imaging without the degradation commonly caused by vignetting.

### Illumination Multiplexing for Bright Field (BF) and Dark Field (DF) Imaging

Multiplexing strategies were investigated to maximize the spatial bandwidth product (SBP) while minimizing the number of required images. Specifically, efficient sampling schemes were developed to selectively retain essential datasets necessary for accurate image reconstruction, thereby discarding redundant image data that would otherwise prolong image acquisition and reconstruction processes.

Additionally, bright-field (BF) imaging and dark-field (DF) imaging were analyzed independently to evaluate their respective data redundancy characteristics and to optimize their corresponding illumination configurations.

The separation of BF and DF imaging provides distinct advantages. Since BF and DF images exhibit inherently different histogram distributions, multiplexing these image types together would hinder the optimal utilization of the camera's dynamic range. Furthermore, BF and DF imaging possess differing noise characteristics; in particular, noise present in BF images tends to dominate over noise in DF images, thereby complicating noise correction procedures in DF imaging when multiplexed.

### Proposed Illumination Scheme

The bright-field (BF) illumination is configured using three objective numerical aperture (NA)-matched asymmetric illuminations, wherein the frequencies cover up to two times the objective NA.

The dark-field (DF) illumination is configured using six multiplexed centro-symmetric DF illuminations, wherein pairs of centro-symmetric DF light-emitting diodes (LEDs) positioned in the same ring are randomly activated. The frequencies of the DF illumination cover up to four times the objective NA.

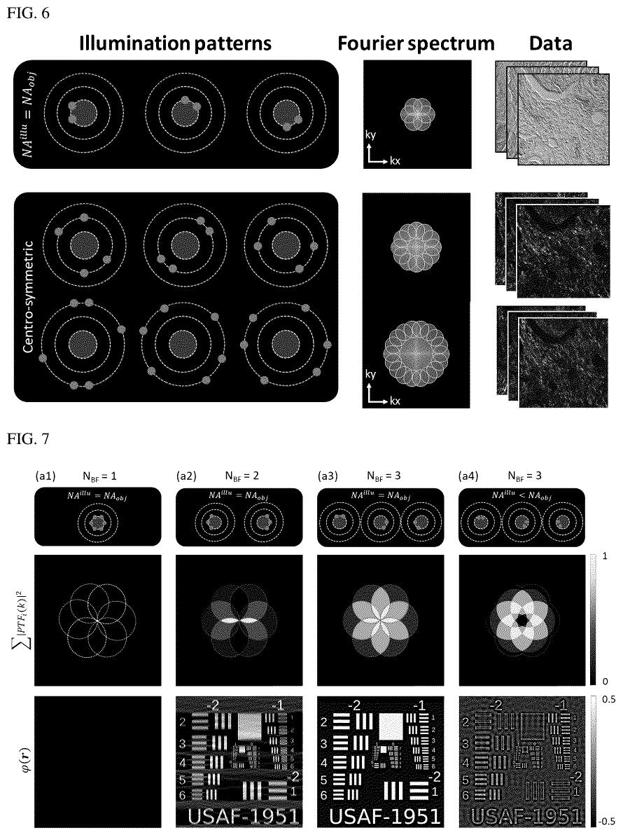

FIG. 6 illustrates a multiplexed illumination scheme used for both bright-field (BF) and dark-field (DF) imaging in a Fourier ptychography system, according to an embodiment of the present disclosure. The figure demonstrates how different illumination patterns correspond to their respective Fourier spectrum coverage and acquired raw images (data).

In the upper row, an example of bright-field (BF) imaging is shown. The left panel depicts three illumination patterns in which LEDs are turned on in an asymmetric arrangement, with each source positioned such that the illumination numerical aperture approximately matches the objective NA. This asymmetric pattern enables directional illumination close to the optical axis. The corresponding Fourier spectrum (center panel) shows that the acquired spatial frequency information is concentrated near the center and extends to approximately twice the objective NA due to overlapping coverage. The data (right panel) represents BF raw images where phase contrast is enhanced under low-angle, asymmetrically multiplexed illumination.

In the lower row, a dark-field (DF) imaging configuration is shown. Here, multiple LEDs are activated in centro-symmetric pairs within a single illumination ring. Each green dot in the left panel represents an active LED source, and the placement is symmetric about the optical axis. This symmetry enhances the stability of high-frequency phase recovery. The corresponding Fourier spectrum (center panel) indicates expanded spatial frequency coverage in the high-NA region, reaching up to four times the objective NA. The DF raw images shown in the right panel display enhanced contrast from high-angle scattering, capturing subtle phase variations associated with fine sample details.

These multiplexing strategies enable efficient sampling of the Fourier domain by minimizing the number of illumination states while maintaining high-quality reconstruction. The combination of asymmetric BF and centro-symmetric DF patterns contributes to both low- and high-frequency phase recovery, thereby improving resolution, contrast, and reconstruction speed in computational imaging applications.

### Method

### Illumination Multiplexing for BF Images

### Objective NA-Matched Illumination

As shown in FIG. 7, the NA-matched bright-field (BF) images are crucial for accurately recovering phase information without losing low-frequency components (rightmost column of FIG. 7).

### Minimum BF Image Acquisitions

The minimum number of image acquisitions can be determined through phase transfer function (PTF) analysis derived from the linearized imaging model under the weak object assumption.

Simulations were conducted with varying numbers of BF images (N_{BF}), where N_{BF}=1, 2, and 3, under NA-matched illuminations (leftmost column, center left column, and center right column). Each of the six BF light-emitting diodes (LEDs) was used at least once in every simulated condition to ensure efficient implementation of the Fourier ptychographic microscopy (FPM) algorithm.

The results showed that a minimum of three BF images is necessary to provide sufficient phase contrast across spatial frequencies up to two times the objective numerical aperture (NA) (FIG. 7).

### Illumination Multiplexing for DF Images

Multiplexing a greater number of light-emitting diodes (LEDs) simultaneously reduces the total number of required measurements. However, as a larger portion of the object spectrum is encoded within each measurement, demultiplexing artifacts become more prominent in the reconstructed images. Accordingly, it is essential to determine the appropriate level of data redundancy to enable accurate image reconstruction while minimizing such artifacts.

### Proposed DF Multiplexing Strategy

Multiplexing strategies for dark-field (DF) images were investigated based on two factors: (1) The configuration of LEDs that are illuminated simultaneously. (2) The minimum number of images required to achieve accurate reconstruction.

### LED Illumination Configuration

### Centro-Symmetric DF Illuminations

Theoretical and numerical studies confirmed that multiplexed centro-symmetric illumination improves imaging throughput and reduces demultiplexing artifacts in dark-field (DF) imaging. It was derived that, for objects with negligible absorption or phase (i.e., α(r)˜0 or φ(r)˜0), or for weakly scattering objects exhibiting strong correlation between absorption and phase information, DF images obtained using centro-symmetric illuminations yield twice the intensity information compared to images obtained using a single light-emitting diode (LED). This increase in signal-to-noise ratio (SNR) enhances the stability and reliability of the reconstruction process. Furthermore, DF images generated by activating centro-symmetric LEDs positioned in the same illumination ring produce identical intensity images, thereby reducing ambiguity in frequency updates and minimizing artifacts associated with the demultiplexing process. The derivation of these findings is provided at the end of the specification.

### Randomly Activated Centro-Symmetric DF LED Pairs in the Same Ring

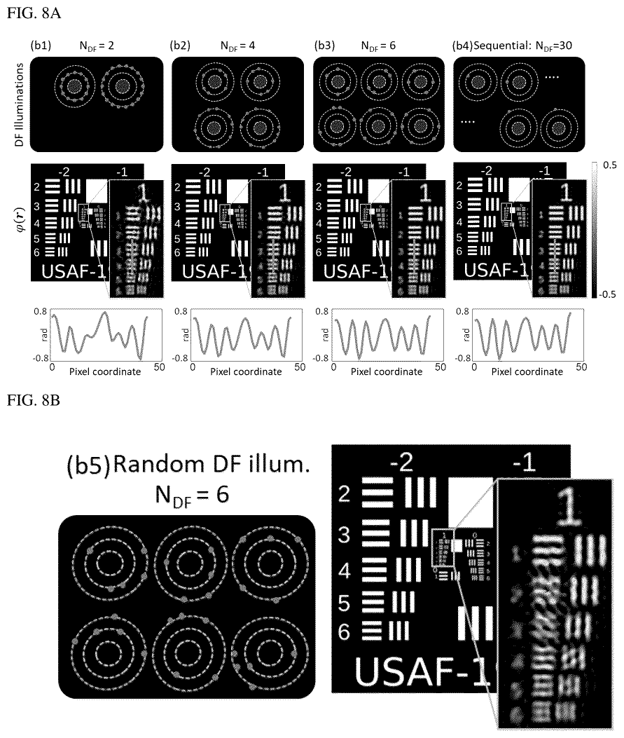

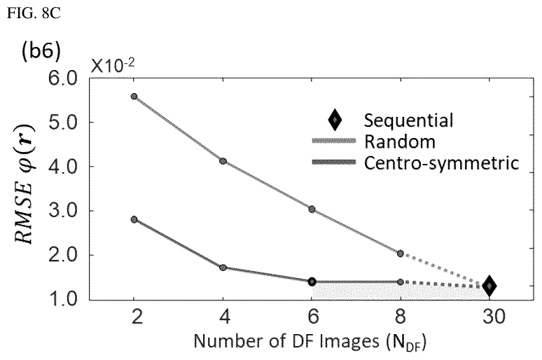

Centro-symmetric DF LED pairs located within the same illumination ring were further randomly activated to extend coverage of the DF spectrum space, as illustrated in FIG. 8A, FIG. 8B, and FIG. 8C. This configuration enables sampling of the object spectrum with uniform spectrum energies. The Fourier space covered by inner LED rings provides an effective initial approximation for the outer rings, thereby improving the stability of the reconstruction algorithm. Additionally, a greater number of LEDs may be multiplexed together in the larger illumination rings, since high-frequency regions of the spectrum do not require the same level of data redundancy as lower-frequency regions.

### Minimum Number of DF Image Acquisitions

Numerical simulations were conducted to determine the minimum number of dark-field (DF) image acquisitions (N_{DF}) required without degrading reconstruction quality.

The simulation results for various N_{DF} values (N_{DF}=2, 4, 6, and 30) are shown in each column of FIG. 7. When N_{DF}=2 or 4, insufficient data redundancy results in artifacts in the reconstructed images. In these cases, as more light-emitting diodes (LEDs) are multiplexed together, the reconstruction algorithm is unable to effectively demultiplex the encoded information. For N_{DF} values equal to or greater than 6, sufficient data redundancy is achieved, producing reconstruction results comparable to those obtained using sequential imaging (root-mean-square error (RMSE) of approximately 0.014, compared to RMSE of approximately 0.013 for the sequential mode with N_{DF}=30).

FIG. 8A presents numerical simulations conducted to evaluate image reconstruction performance under various dark field (DF) illumination conditions. In all simulations, three bright field (BF) illuminations were applied using numerical-aperture-matched asymmetric patterns. The leftmost column shows the result when N_{DF}=2, using a centro-symmetric DF illumination pattern. The center left column shows the result when N_{DF}=4. The center right column illustrates the case of N_{DF}=6. The rightmost column corresponds to a sequential DF illumination scheme with a total of N_{DF}=30. Each configuration includes three components: (i) the DF illumination pattern shown at the top, (ii) the reconstructed USAF resolution image in the middle, and (iii) the corresponding intensity line profile at the bottom. These results demonstrate that increasing the number of DF images improves image clarity and contrast, particularly for high-frequency features.

Additional simulations were performed to compare the proposed illumination scheme with a complete random illumination configuration, in which LEDs located in different rings are randomly activated. As shown in FIG. 8B, reconstructions obtained using the complete random illumination with the same level of data redundancy exhibited pronounced demultiplexing artifacts. The random illumination configuration resulted in a mean RMSE of 0.037, whereas the centro-symmetric DF illumination configuration yielded a lower mean RMSE of 0.018.

FIG. 8B shows an example of a random DF illumination configuration with N_{DF}=6. In this scheme, the DF LEDs are turned on at random positions within the same illumination ring. Although the number of images matches the N_{DF}=6 case from FIG. 8A, the random pattern leads to uneven sampling of Fourier space, resulting in reduced reconstruction quality. The intensity profile shown below the image confirms a decrease in modulation contrast and resolution.

FIG. 8C presents a quantitative comparison of image reconstruction performance for both illumination strategies. The graph plots root-mean-square error (RMSE) values as a function of N_{DF}, comparing random and centro-symmetric DF illumination conditions. The RMSE consistently decreases as N_{DF} increases for both methods. However, the centro-symmetric method outperforms the random pattern across all values of N_{DF}, indicating that structured illumination provides superior reconstruction quality, especially with a limited number of images.

### Derivation: Centrosymmetric Dark-Field Illumination

Consider a weakly scattering object illuminated by an oblique dark-field (DF) plane wave having a wavevector kₗ

$$( where \vert {k}_{l} \vert > \frac{2 π}{λ} {NA}_{obj} ) .$$

The exit wave from the object can be expressed as:

$$φ ( r , {k}_{l} ) = ( 1 - α ( r ) + i φ ( r ) ) exp ( {ik}_{l} \cdot r ) , \qquad ( Equation 1 )$$

where α and φ represent the absorption and phase of the object, respectively, and r denotes spatial coordinates.

The light wave propagating to the detector corresponds to the convolution of the exit wave with the point spread function h(r) of the microscope system:

$$ψ ( r , {k}_{l} ) = ( 1 - α ( r ) + i φ ( r ) ) exp ( {ik}_{l} \cdot r ) ⊗ h ( r ) . \qquad ( Equation 2 )$$

The detected light wave consists of three terms: a background term, an absorption term, and a phase contrast term. The background term can be disregarded because, under oblique DF plane wave illumination, the sub-aperture spectrum is shifted outside the passband of the objective lens, allowing only the scattered light from the object to pass through. The intensity recorded at the detector is given by:

$$I ( r , {k}_{l} ) = ψ ( r , {k}_{l} ) \cdot \overline{ψ ( r , {k}_{l} )} \qquad ( Equation 3 )$$

Expanding this yields:

$$I ( r , {k}_{l} ) = ( ( - α ( r ) \cdot exp ( {ik}_{l} \cdot r ) + i φ ( r ) \cdot exp ( {ik}_{l} \cdot r ) ) ⊗ h ( r ) ) \cdot ( ( - \overline{α ( r )} \cdot exp ( - {ik}_{l} \cdot r ) - \overline{i φ ( r )} \cdot exp ( - {ik}_{l} \cdot r ) ) ⊗ \overline{h ( r )} ) \qquad ( Equation 4 )$$

Where .̅ denotes complex conjugation.

Since both α(r) and φ(r) are real functions, the DF intensity image can be rewritten as:

$$I ( r , {k}_{l} ) = ( α ( r ) exp ( i {k}_{l} \cdot r ) ⊗ h ( r ) ) ( α ( r ) exp ( - i {k}_{l} \cdot r ) ⊗ h ( r ) ) + ( φ ( r ) exp ( {ik}_{l} \cdot r ) ⊗ h ( r ) ) ( φ ( r ) exp ( - {ik}_{l} \cdot r ) ⊗ h ( r ) ) + 2 ( ( φ ( r ) cos ( {k}_{l} \cdot r ) ⊗ h ( r ) ) ( α ( r ) sin ( {k}_{l} \cdot r ) ⊗ h ( r ) ) - ( α ( r ) cos ( {k}_{l} \cdot r ) ⊗ h ( r ) ) ( φ ( r ) sin ( {k}_{l} \cdot r ) ⊗ h ( r ) ) ) \qquad ( Equation 5 )$$

For objects with negligible absorption or phase (i.e., α(r)˜0 or φ(r)˜0), or for objects exhibiting significant structural correlation between absorption and phase (i.e., α(r)˜γφ(r) with γ being a small constant), the cross-terms involving absorption and phase can be neglected. This simplification reduces the intensity expression to:

$$I ( r , {k}_{l} ) = ( α ( r ) exp ( i {k}_{l} \cdot r ) ⊗ h ( r ) ) ( α ( r ) exp ( - i {k}_{l} \cdot r ) ⊗ h ( r ) ) + ( φ ( r ) exp ( {ik}_{l} \cdot r ) ⊗ h ( r ) ) ( φ ( r ) exp ( - {ik}_{l} \cdot r ) ⊗ h ( r ) ) \qquad ( Equation 6 )$$

$$I ( r , {k}_{l} ) = \vert a ( r ) exp ( i {k}_{l} \cdot r ) ⊗ h ( r ) {\vert}^{2} + \vert φ ( r ) exp ( {ik}_{l} \cdot r ) ⊗ h ( r ) {\vert}^{2} \qquad ( Equation 7 )$$

Similarly, when the object is illuminated by two symmetric DF plane waves with wavevectors kₗ and −kₗ, the resultant DF intensity becomes:

$$I ( r , {k}_{l} ) + I ( r , - {k}_{l} ) = 2 \vert a ( r ) exp ( i {k}_{l} \cdot r ) ⊗ h ( r ) {\vert}^{2} + 2 \vert φ ( r ) exp ( {ik}_{l} \cdot r ) ⊗ h ( r ) {\vert}^{2} \qquad ( Equation 8 )$$

From Equations (7) and (8), it is evident that, for objects with negligible absorption or phase (i.e., α(r)˜0 or φ(r)˜0), or for weakly scattering objects exhibiting strong correlation between absorption and phase information, the DF images obtained using centro-symmetric illuminations yield twice the intensity information compared to DF images obtained using a single light-emitting diode (LED).

Although the above description has been made with reference to the preferred embodiment of the present disclosure, those skilled in the art will appreciate that the present disclosure may be variously modified and changed within the scope not departing from the spirit and region of the present disclosure described in the following claims.

What is claimed is:

1. A method for removing vignetting of a light source array, the method comprising:
placing lenses respectively on front surfaces irradiated with light of at least some of light sources included in the light source array,
wherein each lens is disposed such that each light source generates quasi-collimated illumination.

2. The method of claim 1, wherein the lenses are equally prepared with predetermined material and shape,
wherein each light source is disposed to generate the quasi-collimated illumination by adjusting a distance of each lens to each light source and an offset distance between a center of each lens and a center of each light source.

3. The method of claim 1, wherein each light source is prepared to include an LED.

4. A light irradiation apparatus with vignetting removed, the light irradiation apparatus comprising:
a light source array; and
a lens array including lenses respectively disposed on front surfaces irradiated with light of at least some of light sources included in the light source array,
wherein each lens is disposed such that each light source generates quasi-collimated illumination.

5. The light irradiation apparatus of claim 4, wherein the lenses have the same material and shape,
wherein each light source is disposed to generate the quasi-collimated illumination by adjusting a distance of each lens to each light source and an offset distance between a center of each lens and a center of each light source.

6. The light irradiation apparatus of claim 4, wherein each light source includes an LED.

7. A Fourier ptychography apparatus with vignetting removed, the Fourier ptychography apparatus comprising:
a light irradiation apparatus including:
a sample portion where a sample to be irradiated with light is able to be disposed;
a light source assembly configured to irradiate light to the sample portion;
a sensor configured to obtain an image generated from the sample portion by light irradiated by the light source assembly; and
a calculator configured to calculate and obtain a high-resolution image from the image,
wherein the light source assembly includes: a light source array; and a lens array including lenses respectively disposed on front surfaces irradiated with light of at least some of light sources included in the light source array, wherein each lens is disposed such that each light source generates quasi-collimated illumination on the sample portion.

8. The Fourier ptychography apparatus of claim 7, wherein the lenses have the same material and shape,
wherein each light source is disposed to generate the quasi-collimated illumination by adjusting a distance of each lens to each light source and an offset distance between a center of each lens and a center of each light source.

9. The Fourier ptychography apparatus of claim 7, wherein the light source assembly is configured to emit light to the sample portion in two or more patterns,
wherein the sensor is configured to obtain two or more images from light irradiated in the two or more patterns,
wherein the calculator is configured to calculate the high-resolution image from the two or more images.

10. The Fourier ptychography apparatus of claim 7, wherein each light source includes an LED.

11. The Fourier ptychography apparatus with vignetting removed according to claim 7,
wherein the light source assembly includes a bright field light source and a dark field light source,
wherein the bright field light source is configured to form an asymmetric pattern, and
wherein the dark field light source is configured to form six or more centro-symmetric patterns.

12. A method for obtaining FP high-resolution image with a reduced exposure time, the method comprising:
obtaining a high-resolution image of a sample to be analyzed using the Fourier ptychography apparatus with the vignetting removed according to claim 7,
wherein an exposure time for the sensor to obtain the image is reduced to 1/70 to 1/125 of an exposure time required when the lens array is removed from the light irradiation apparatus.
